(19) United States
(12) Patent Application Publication
(10) Pub. No.: US 2010/0116589 A1
(43) Pub. Date: May 13, 2010

(54) GUTTER PROTECTION AND LADDER SUPPORT APPARATUS

(76) Inventor: Thomas R. Mathieson, Louisville, CO (US)

Correspondence Address: POLSINELLI SHUGHART PC, 700 West 47th Street, Suite 1000, KANSAS CITY, MO, 64112, US

(21) Appl. No.: 12/618,618

(22) Filed: Nov. 13, 2009

Related U.S. Application Data
(60) Provisional application No. 61/114,393, filed on Nov. 13, 2008.

(51) Int. Cl. E06C 7/48

(52) U.S. Cl. 182/107

(57) ABSTRACT

A gutter protection and ladder support apparatus includes a ladder securing apparatus and a plate section. The plate section has a plate surface that is bent to form a first face member and a second face member. The first face member is formed at an angle from the plate surface. The ladder securing apparatus is connected to the plate section and is configured to secure a ladder against the plate section. The ladder securing apparatus is adjustable for selective fastening of the ladder to the plate section.

### RELATED APPLICATIONS

This application claims priority to U.S. Provisional Application No. 61/114,393, filed Nov. 13, 2008, the entire contents of which are incorporated herein by reference.

### FIELD OF THE INVENTION

The present invention relates in general to gutter protection devices. More particularly, the present invention relates to an apparatus designed to securely support a ladder which is placed against a gutter and to protect the gutter from potential damage caused by a ladder placed against it.

### BACKGROUND OF THE INVENTION

The construction of gutters and the placement thereof against the fascia board of a building structure is well known in the art. Gutters are typically made of a thin extruded material such as aluminum or vinyl and are subject to damage when ladders are placed against them, particularly when workmen or a homeowner climbs up and down a ladder so positioned carrying heavy loads, such as shingles or other roofing materials. The pressure exerted by a ladder against a gutter under these conditions typically bends or crushes it, which not only destroys the aesthetics of the guttered roofline, but also may cause clogging of the gutter and present an unstable and hazardous ladder position.

Considerable prior art exists which shows various attempts at solving these related problems. By way of example, U.S. Pat. No. 5,358,071 issued to Stennett on Oct. 25, 1994 discloses a gutter protecting ladder attachment which fits inside a gutter channel and includes a pair of spaced apart legs and a transversely extending support rod disposed through each of the legs and a hollow rung of the ladder which are designed to provide support therefor. However, the structure of this device is fixed in dimension so that only ladders that are sufficiently narrow in width to fit between the supporting legs may be used in conjunction with it. Moreover, it is susceptible to bending and distortion through repeated use, and, eventually, would become misaligned to the point where it would require straightening prior to continued use.

U.S. Pat. No. 6,354,401 issued to Murray on Mar. 12, 2002 discloses a U-shaped gutter saver and ladder support which fits over the gutter channel and rests against the fascia board to which the gutter is affixed. This device includes a pair of spaced apart brackets which are positioned to prevent the ladder from sliding laterally. However, the support disclosed in the '401 patent is positioned to rest over the gutter up against the fascia board and, being unsecured thereto, is susceptible to being dropped during the installation and removal process or slippage while in use.

Accordingly, a need exists for an improved lightweight yet strong and stable gutter protection and ladder support apparatus which will overcome the shortcomings of the prior art devices set forth above.

### SUMMARY OF THE INVENTION

In order to achieve the above mentioned object and other objects of the present invention, a gutter protection and ladder support apparatus is provided that basically comprises a plate section and a ladder securing apparatus. The plate section has a plate surface that is bent to form a first face member and a second face member. The first face member is formed at an angle from the plate surface. The ladder securing apparatus is connected to the plate section and is configured to secure a ladder against the plate section. The ladder securing apparatus is adjustable for selective fastening of the ladder to the plate section.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

FIG. 1 is a front elevational view of a gutter protection and ladder support apparatus in accordance with an embodiment;

FIG. 2 is a side perspective view of the gutter protection and ladder support apparatus installed on a roof and having a ladder secured by a first embodiment of a ladder securing means;

FIG. 3 is a side elevational view of the apparatus installation of FIG. 2;

FIG. 4 is a close up view of a portion of the ladder securing means in accordance with an embodiment;

FIG. 5 is a front plane view of the apparatus installation of FIGS. 2 and 3;

FIG. 6 is a perspective view of a ladder mount apparatus, in accordance with a second embodiment of the ladder securing means, mounted to the gutter protection and ladder support apparatus;

FIG. 7 is a magnified perspective view of the ladder mount apparatus mounted to the gutter protection and ladder support apparatus;

FIG. 8A is a perspective view of a second embodiment of the gutter protection and ladder support apparatus;

FIG. 8B is a cross-sectional view of a gutter with the second embodiment of the gutter protection and ladder support apparatus disposed therein;

FIG. 9 is a cross-sectional view of an alternative embodiment of that shown in FIG. 8B.

FIG. 10 is a perspective view of a third embodiment of the gutter protection and ladder support apparatus;

FIG. 11A is a cross-sectional view of a gutter with the third embodiment inserted and partially folded in the gutter;

FIG. 11B is a cross-sectional view of a gutter with the third embodiment installed therein;

FIG. 12 is a perspective view of a fourth embodiment of the gutter protection and ladder support apparatus with first and second portions separated;

FIG. 13A is an exploded perspective view of the fourth embodiment of the gutter protection and ladder support apparatus;

FIG. 13B is a cross-sectional view of an alternative embodiment for connecting the separate first and second portions;

FIG. 14 is a perspective view of the fourth embodiment with the first and second portions attached;

FIG. 15 is a perspective view of a fourth embodiment of the ladder mount apparatus;

FIG. 16 is a cross-section of a ladder coupled at an outer rail to the fourth embodiment of the gutter protection and ladder support apparatus by the fourth embodiment of the ladder mount apparatus;

FIG. 17 is a cross-section of a ladder coupled at an inner rail to the fourth embodiment of the gutter protection and ladder support apparatus by the fourth embodiment of the ladder mount apparatus;

FIG. 18 is a perspective view of a fifth embodiment of the gutter protection and ladder support apparatus installed over a gutter;

FIG. 19 is a perspective view of a sixth embodiment of the gutter protection and ladder support apparatus installed in and over a gutter;

FIG. 20 is a cross section of the ladder support apparatus and gutter of FIG. 19;

FIG. 21 is a perspective view of a ladder support apparatus coupled to a pivot piece attached to a fascia board;

FIG. 22 is a perspective view of the pivot piece in FIG. 21;

FIG. 23A is a rear perspective view of a ladder support apparatus having support members forming a narrow aperture to accommodate a band in a gutter; and

FIG. 23B is a rear perspective view of a ladder support apparatus having support members forming a wide aperture to accommodate a band in a gutter.

### DETAILED DESCRIPTION OF THE INVENTION

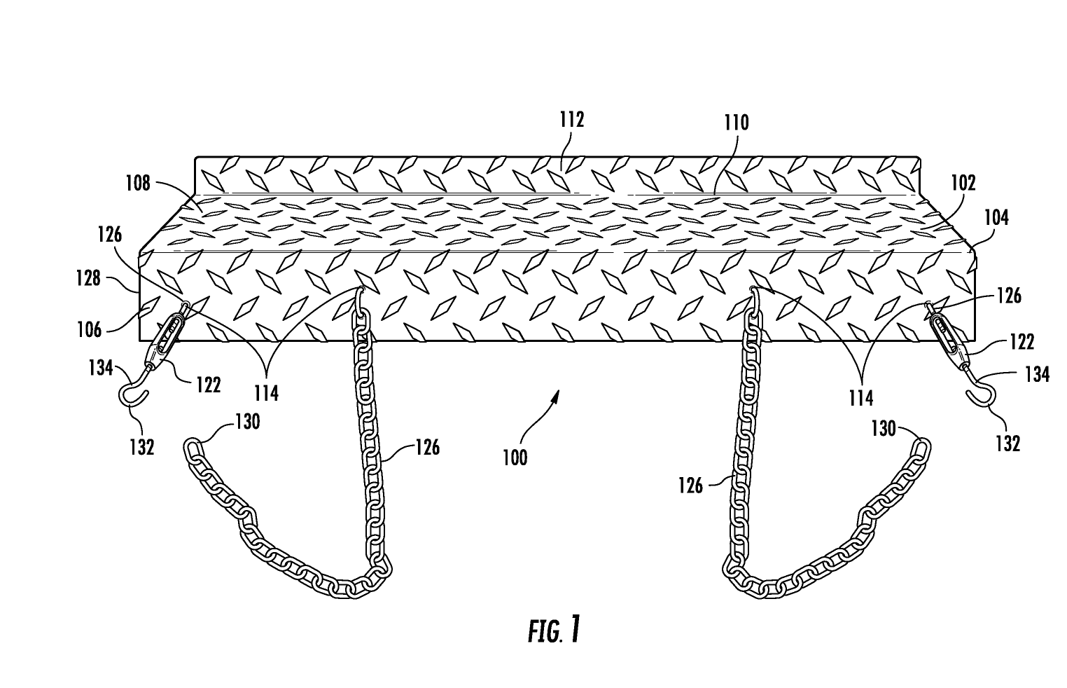

Referring now to the drawings and in particular, to FIG. 1, a gutter protection and ladder support apparatus in accordance with the present invention is shown generally at 100. In the embodiment shown, the apparatus is formed from metal, by way of example a light gauge steel or aluminum sheet or plate 102; although, other materials and configurations may be used without departing from the scope of the present invention. The plate 102 is bent along an edge or corner 104 to form a first face member 106, which is formed at an angle to the plate surface 108 to permit a ladder 150 to be leaned up against it. Specifically, the angle of the first face member 106 ensures placement of the ladder 150, resting thereon, at an angle ideal for a workman or homeowner to safely ascend or descend the ladder 150, especially when carrying a load. A second bend along edge or corner 110 forms a second face member 112 which is also generally perpendicular to plate surface 108 and substantially parallel to the first face member 106. The first face member 106 further contains a plurality of apertures 114 formed therein which are adapted to receive means 120 for securing a ladder which may be placed against the apparatus 100 after it is secured to a roof or other building structure.

In another embodiment, the ladder support apparatus 100 may be comprised of two plates which are mirror images of one another and overlap to form generally the same configuration as plate 102 in the above-referenced embodiment. In the alternate embodiment, the two overlapping plates are slideably juxtaposed one on top of the other so that the plates may be adjusted to fit gutters of varying sizes and configurations. One plate would be secured to the fascia board as before, and the second plate would be secured to a ladder. The plates are attached to each other to prevent shifting once in position by suitable fastening means such as by threaded fasteners, releasable clamps, and the like, and may be loosened and moved to a new position along a roof structure, as needed.

In the embodiment of FIG. 1, the ladder securing means or apparatus 120 is coupled to the first face member 106 on which the ladder 150 rests to ensure a sturdy and secure ladder 150 with less play or movement. The ladder securing means 120 comprises a turnbuckle 122 disposed in one of the apertures 114 and having a first end 124 extending therethrough, a chain 126 secured to the first end 124 of the turnbuckle and extending along the back surface 128 of the first face member and then outwardly through aperture 114. The chain 126 includes a second end 130 which is adapted to be received by a hook 132 formed in a second end 134 of the turnbuckle 122. The chain is of sufficient length to be adjustably secured around the legs of a ladder positioned against the apparatus and may be either lengthened or shortened, depending upon the ladder size. While a chain/turnbuckle system is illustrated in the figures, it is to be understood that it is for purposes of illustration only, and other securing means may be employed without departing from the scope of the instant invention. By way of example, a ladder 150 may be secured to the apparatus by Velcro straps, a releasable lever with an eccentric cam device to retain it in a locked position, adjustable, releasable straps analogous to those used for seat belts in automotive applications, and the like.

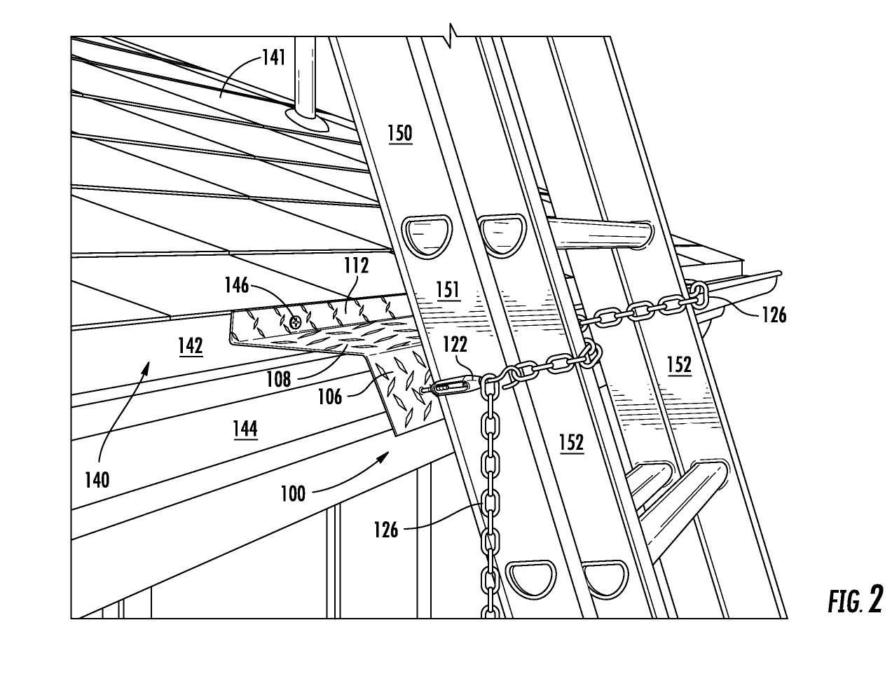

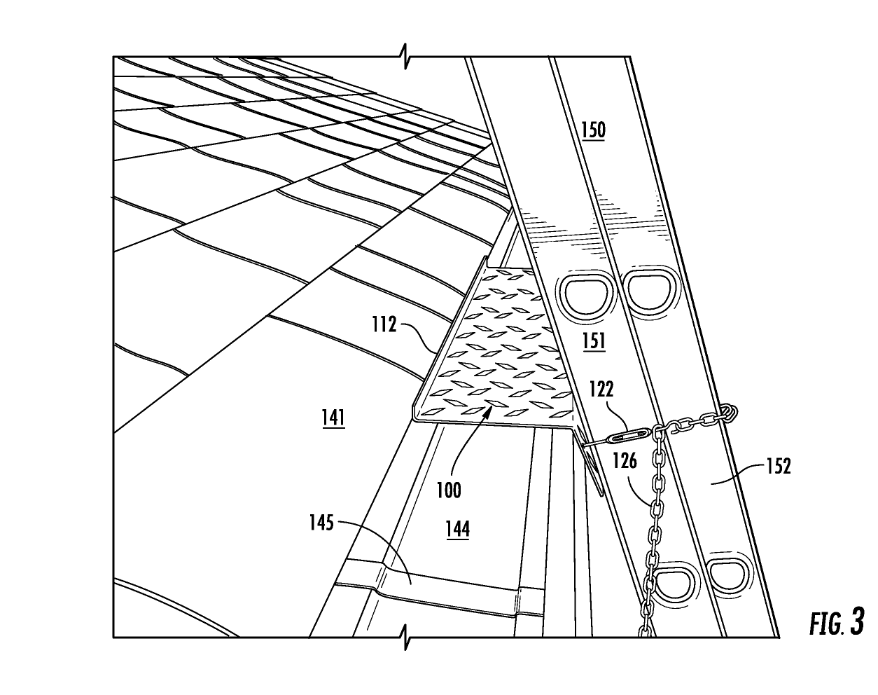

Turning now to FIGS. 2-5, the gutter protection and ladder support apparatus 100 of the present invention is shown installed on the side of a building roof structure 140. The roof structure includes a shingled roofing surface 141, a fascia board 142 extending generally vertically downwardly from the roofing surface, and a gutter 144 secured to the side of the structure 140 and arranged for catching water runoff from the roofing surface 141, as is known in the art.

The gutter protection and ladder support apparatus 100 is secured to the fascia board 142 by means of suitable fasteners, which in the instant embodiment, are in the form of a plurality of threaded screws, one of which is shown at 146, that may be removably inserted through apertures formed in the second face member 112. A ladder 150 having a pair of extensible legs 152 is positioned leaning against the support apparatus and releasably secured thereto by means of the chains 126 and turnbuckles 122. The width of the support apparatus 100 is such that it may accommodate ladders 150 of varying sizes, and the chains and turnbuckles may be adjusted to adapt to ladders 150 of varying widths and legs of varying sizes so that the ladder 150 itself is tightly secured against the first face member 106. By tightening the turnbuckle 122, the ladder 150 may be rigidly secured to the gutter protection and ladder support apparatus 100 such that a workman or homeowner may carry heavy loads up and down the ladder without fear that it will shift sideways or slide out from beneath him or her.

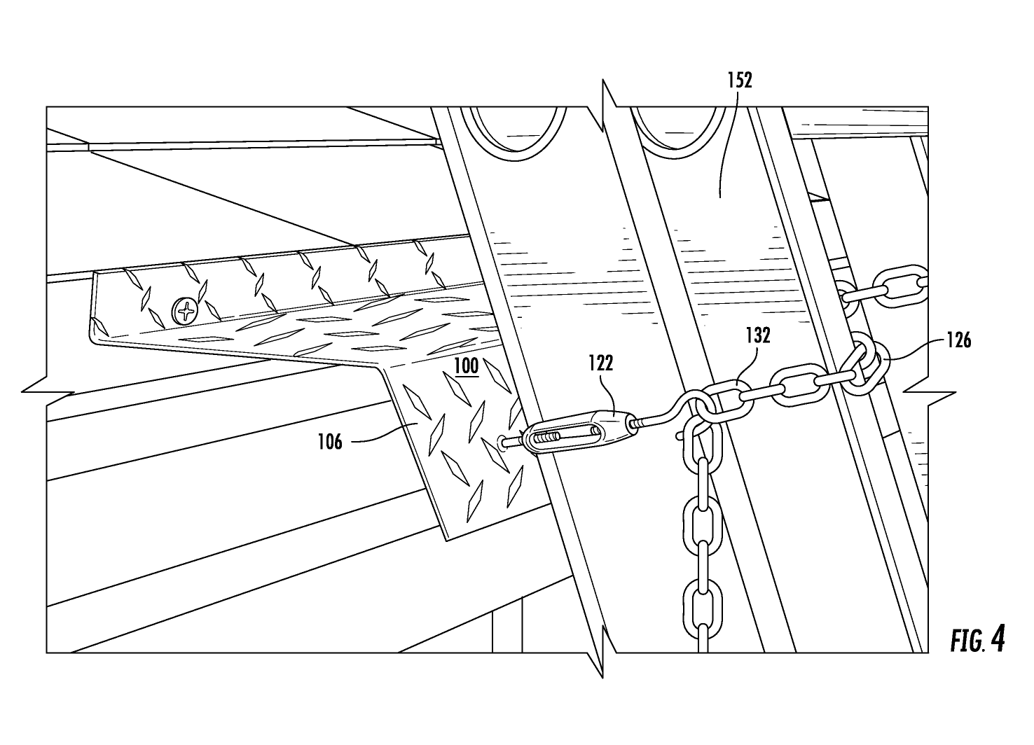

As an alternative to the ladder securing means 120 described above, FIGS. 6 and 7 provide an embodiment for securing the ladder 150 to the gutter protection and ladder support apparatus 100 that includes a ladder mount apparatus 154. The ladder mount apparatus 154 is directly coupled to the first face member 106, on which the ladder 150 rests. The ladder mount apparatus 154 is formed from metal, by way of example, a light gauge steel or aluminum sheet or plate 102; although, other materials and configurations may be used without departing from the scope of the present invention. Further examples of materials for the ladder mount apparatus 154 include alloys, such as steel, brass, bronze and duralumin, plastic, wood, high density polyethelene, PVC, polycarbonate, accrylonitrile butadiene styrene, or polycarbonate/accrylonitrile butadiene styrene. The ladder mount apparatus 154 includes a mount portion 156, a connector portion 168 and a securing portion 172 to effectively secure the ladder 150 to the gutter protection and ladder support apparatus 100. The ladder mount apparatus 154 is bent on both ends of the connector portion 168 to form the mount portion 156 and the securing portion 172. In the embodiment illustrated in FIGS. 6-7, the ladder mount apparatus 154 is an integral, unitary, one-piece member. However, it will be apparent to one of ordinary skill in the art from this disclosure that the ladder mount apparatus 154 can have several parts coupled together. For example, the connector portion 168 may include adjustable plates together with a coupling-adjustment device that allow the length of the connector portion 168 to be lengthened or shortened.

The securing portion 172 includes a first securing member 174 and a second securing member 176. The first securing member 174 extends from an end of the connector portion 168 and is configured to also extend along a face of the leg 152 of the ladder 150. The first securing member 174 extends generally perpendicular to the connector portion 168 and is substantially parallel to the first face member 106 when the ladder mount apparatus 154 is mounted to the gutter protection and ladder support apparatus 100. The second securing member 176 extends from an end of the first securing member 174 that is opposite the connector portion 168. The second securing member 176 acts as a guard or closure to secure the ladder 150 between the second securing member 176 and the connector portion 168. The second securing member 176 extends generally perpendicular from the first securing member 174.

At the end of the connector portion 168 opposite the first securing member 174 is the mount portion 156. The mount portion 156 extends generally perpendicular from the connector portion 168. In addition, the mount portion 156 is configured to rest on the first face member 106 and generally extends parallel to the first face member 106. The mount portion 156 has a slot 162 located substantially in the center of the mount portion 156. The slot 162 extends longitudinally along the mount portion 156. A threaded rod 164 and wing nut 166 constitute one example of a means for securing the ladder mount apparatus 154 to the ladder support apparatus. The threaded rod 164 can be inserted through one of the apertures 114 and welded to a surface opposite or on the backside of the first face member 106. Alternatively, the threaded rod 164 can be a bolt, wherein a head of the bolt is on the backside of the first face member and the threaded portion attaches to the wing nut 166. Thus, the ladder 150 is clamped onto the first face member 106 by placing the threaded rod 164 through the slot 162 of the ladder mount apparatus 154 and tightening the wing nut 166 such that the ladder mount apparatus 154 cannot move relative to the threaded rod 164. The slot 162 allows selective longitudinal movement of the ladder mount apparatus 154 for adjustment according to the position of the ladder 150, rather than adjusting the position of the ladder 150 relative to the ladder mount apparatus 154. The slot 162 also allows ladders 150 of different sizes or widths to be used with the gutter protection and ladder support apparatus 100.

In operation, the ladder mount apparatus 154 serves to trap or secure the ladder 150 to the gutter protection and ladder support apparatus 100 to ensure limited or no ladder 150 movements while a workman or homeowner ascends or descends the ladder 150. That is, the connector portion 168 is on the outer side of the ladder 150, the first securing member 174 is over the upper face of the ladder 150 and the second securing member 176 is on an inner side of the ladder 150. Thus, the ladder mount apparatus 154 of the present invention provides a rigid structure on three surfaces of the ladder 150. The connector portion 168 has a length such that it positions the first securing member 174 so that it may extend over the upper face of the ladder 150. The length of the connector portion 168 is about the same as a width of the extensible leg 152 and the non-extensible leg of the ladder 150. Alternatively, the ladder mount apparatus 154 may be provided with a connector portion 168 having a length that is about the same as the non-extensible leg. This is advantageous if the workman or homeowner ascends or descends while carrying a load and most advantageous if carrying an unbalanced load, i.e. the load is carried away from the person's center of gravity.

The slot 162 enables the ladder mount apparatus 154 to be selectively adjustable or slideably moveable in the longitudinal direction of the first face member 106. Thus, not only does the ladder mount apparatus 154 place a clamping force on the ladder 150 (down toward first face member 106), but the ladder mount apparatus 154 may also place a lateral force (in the longitudinal direction of the first face member 106) on the ladder 150 from both inner sides of the ladder 150 via the second securing member 176, thereby increasing the hold on the ladder 150 and the sturdiness of the ladder. Alternatively, the pair of ladder mount apparatuses 154 may place a squeezing force on the ladder 150 by sliding the ladder mount apparatus 154 such that the connector portions 168 push on the outer sides of the ladder 150—followed by tightening the wing nut 166 such that the ladder mount apparatus 154 cannot move relative to the threaded rod 164.

The embodiment illustrated in FIGS. 6 and 7 is but one example of the ladder mount apparatus 154. It will be apparent to one of ordinary skill in the art from this disclosure that the ladder mount apparatus 154 can be serpentine or the like, i.e. the corners do not have to be angled, but can be curved, chamfered, etc.

While only one ladder mount apparatus 154 is shown in FIGS. 6 and 7, and indeed, only one may be used in operation, it is preferable that a pair of the ladder mount apparatuses 154 is disposed on the first face member 106 as mirror images of one another. Furthermore, washers may be used in conjunction with the wing nut 166 and the threaded rod 164.

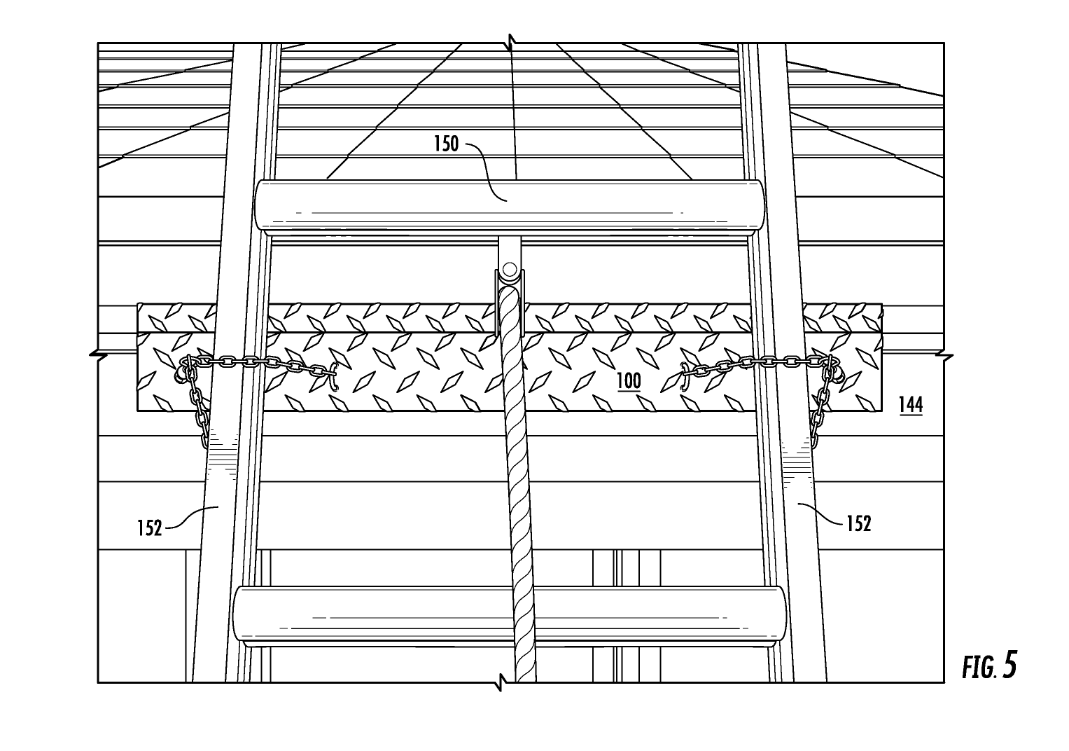

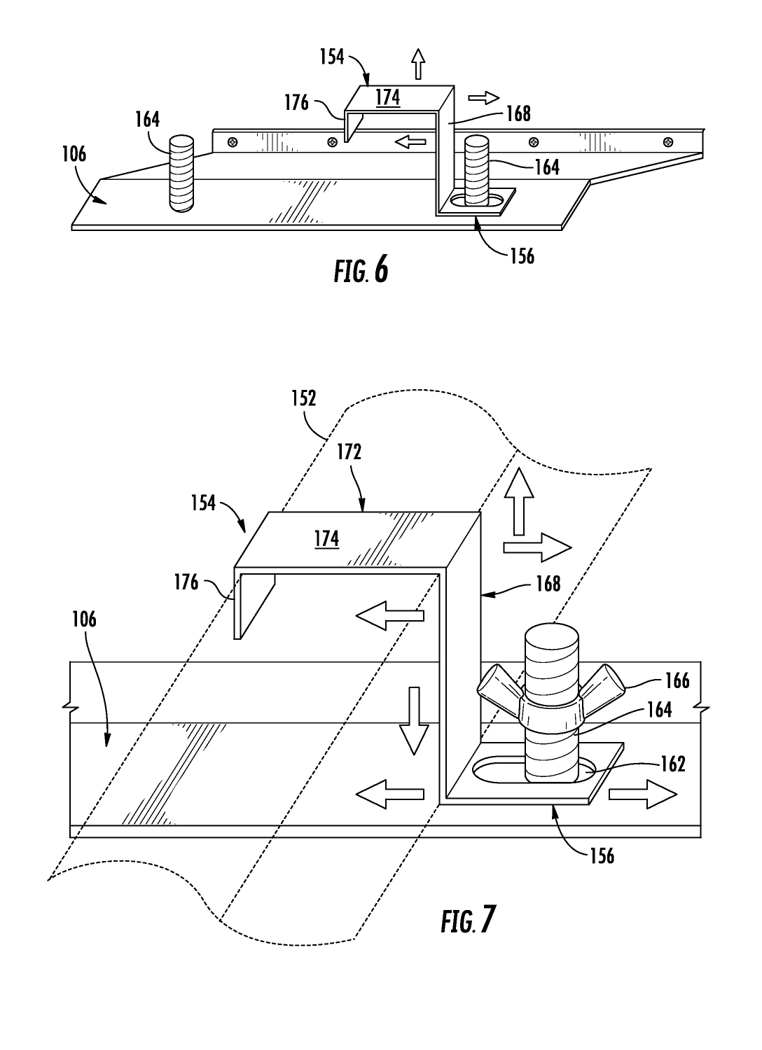

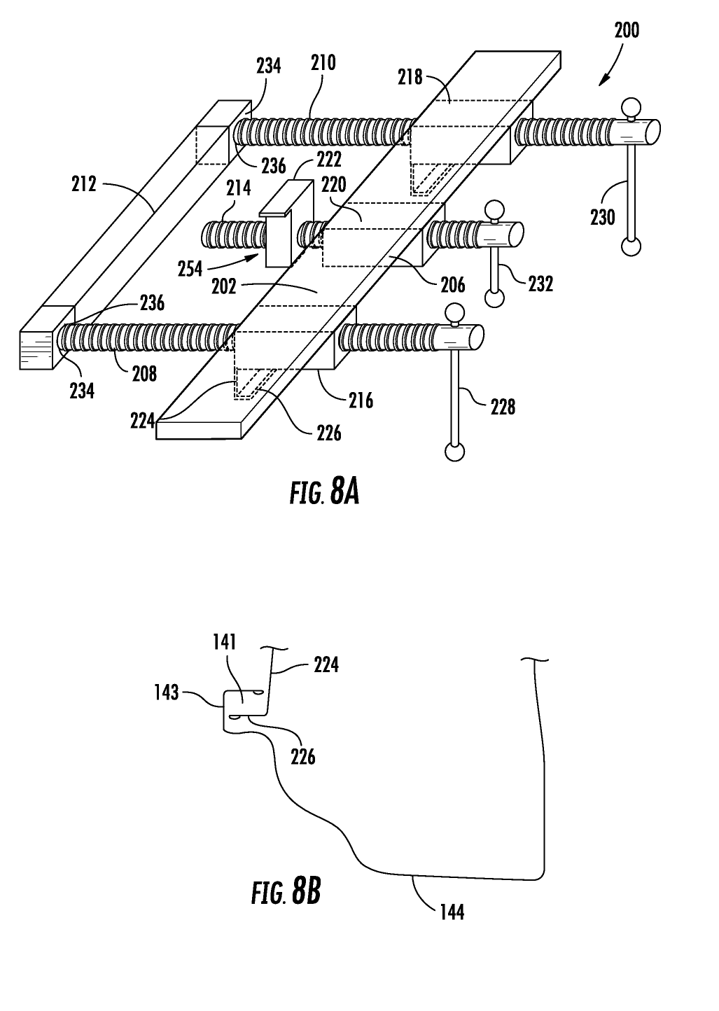

FIG. 8A illustrates a second embodiment of the ladder support apparatus 200 that is adjustable. The ladder support apparatus 200 advantageously avoids attachment to the fascia board 142 via screws. The ladder support apparatus 200 includes a plate 202 having a first face member 206 that provides a surface, on which the ladder 105 can rest, and a second face member 212. The second face member 212 is configured to be placed against the fascia board 142. The ladder support apparatus 200 further includes a first translation screw 208 and a second translation screw 210. The first and second translation screws 208, 210 rotate within the second face member 212. The first and second translation screws 208, 210 and the plate 202 can be formed from metal, by way of example, a light gauge steel or aluminum; although, other materials may be used without departing from the scope of the present invention. Examples of other materials include alloys, such as steel, brass, bronze and duralumin, plastic, wood, high density polyethelene, PVC, polycarbonate, accrylonitrile butadiene styrene, or polycarbonate/accrylonitrile butadiene styrene.

The second face member 212 has an opening 234 at each end with a bearing 236 in each opening 234. The bearings 236, which are coupled to the first and second translation screws 208, 210 facilitate rotational movement of the first and second translation screws 208, 210. The plate 202 includes a first nut section 216 and a second nut section 218, each of which have female threads therein. The first and second nut sections 216, 218 are attached to an underside of the plate 202 at respective ends of the plate 202. The first translation screw 208 extends through the first nut section 216 and male threads of the first translation screw 208 mate with female threads of the first nut section 216. Likewise, the second translation screw 210 extends through the second nut section 218 and the male threads of the second translation screw 210 mate with the female threads of the second nut section 218. The first and second translation screws 208, 210, have a handle 228 and 230, respectively. The handles 228, 230 are used to rotate the respective translation screw 208, 210. When the first or second translation screw 208, 210 is rotated in the bearing 236, the rotational movement is translated into axial movement of the plate 202.

The first and second translation screws 208, 210 each have a self-locking mechanism that is advantageous for the workman or homeowner. Specifically, when the first or second translation screw 208, 210 is not rotated, axial movement of the plate 202 is prevented via the mated male and female threads. The translation screws 208, 210 and nut sections 216, 218 provide accurate axial motion of the plate 202 in a compact construction that is advantageous for placement in the limited area of the gutter 144. Furthermore, the translation screws 208, 210 operate in a smooth, noiseless manner and are virtually maintenance free. Furthermore, the ladder support apparatus 200 has few parts, which reduces cost and generally increases reliability.

The plate 202 further includes a flange 224 having a tongue 226. The flange 224 extends downwardly on a side closest to the second face member 212 from a bottom surface of the plate 202 in a generally perpendicular direction from the plate 202. The tongue 226 extends from an end of the flange 224 opposite the plate 202 in a generally perpendicular direction from the flange 224. The tongue 226 is configured to contact the inside of the front or outermost part 143 of the gutter 144. The outermost part 143 of the gutter 144 is bent to form a pocket 141, as shown in the cross-sectional view of the gutter 144 in FIG. 9. Preferably, the flange 224 and tongue 226 hook into the outermost part 143 of the gutter 144 at the pocket 141 as illustrated in FIG. 8B. FIG. 9 illustrates an alternative embodiment of the nut sections 216, 218 wherein a translation screw 208 passes through the plate 202.

Thus, in operation, the second face member 212 is placed against the fascia board 142 with the plate 202 preferably adjacent the second face member 212 and the first and second translation screws 208, 210 are turned such that the plate 202 moves axially in a direction away from the second face member 212 until the flange 224 and tongue 226 hook into the pocket 141. The first and second translation screws 208, 210 are rotated until there is a sufficient amount of force on the outermost part 143 to wedge the second face member 212 and the flange 224 (via the tongue 226) between the fascia board 142 and the outermost part 143, yet avoid bending the gutter 144. Once the ladder support apparatus 200 is in position at the gutter 144, the first face member 206 protects the gutter 144 since it is disposed in front of the outermost part 143, thereby serving as a surface for the ladder 150 to rest thereon.

The ladder 150 is secured to the ladder support apparatus 200 by a third embodiment of the ladder securing means or apparatus 120, which includes a ladder mount apparatus 254. The ladder mount apparatus 254 includes a third translation screw 214 having a handle 232, a third nut section 220 and a fourth nut section 222. The third and fourth nut sections 220, 222 both receive the third translation screw 214. Specifically, male threads of the third translation screw 214 mate with female threads of the third and fourth nut sections 220, 222. The third nut section 220 is immovably disposed on the underside of the plate 202, whereas the fourth nut section 222 is movable relative to the third nut section 220 by rotating the third translation screw 214. One end of each of the chains 126 is secured to the first face member 206 in the same location as the hooks 132 in FIG. 1, for example. The chains 126 are wrapped around the stiles 151 of the ladder 150 and the other end of each of the chains 126 is guided between the stiles 151 to be attached to the fourth nut 222. The rotation of the third screw 214 causes the fourth nut section 222 to move axially. To tighten the chains 126, the third screw 214 is rotated via the handle 232 such that the fourth nut section 222 moves axially away from the plate 202 and the third nut section 220. Thus, the fourth nut section 222 can be selectively positioned to provide a desired amount of tension in the chains 126 as the workman or homeowner needs to safely secure the ladder 150 to the first face member 206.

FIG. 10 illustrates a third embodiment of the ladder support apparatus 300 that snaps into place at the gutter 144. The ladder support apparatus 300 includes a plate 302 having a first face member 306, and a second face member 312. The plate 302 includes a first portion 303, a second portion 305, a hinge 315, a sub-layer 323, a flange 324 and a tongue 326. The plate 302 can be formed from metal, by way of example, a light gauge steel or aluminum; although, other materials may be used without departing from the scope of the present invention. Examples of other materials include alloys, such as steel, brass, bronze and duralumin, plastic, wood, high density polyethelene, PVC, polycarbonate, accrylonitrile butadiene styrene, or polycarbonate/accrylonitrile butadiene styrene. The hinge 315 is disposed between the first face member 306 and the second face member 312. Specifically, the hinge 315 is disposed between the first and second portions 303 and 305 and joins the first and second portions 303 and 305 together. The sub-layer 323 of the plate 302 extends out of the first face member 306 and then curves underneath the plate 302. The hinge 315 is attached to the first and second portions 303, 305 underneath the plate 202, i.e. on the same side of the plate that the sub-layer 323 is located. At an end of the sub-layer 323 the flange 324 extends generally perpendicular to the plate 302. It will be apparent to one of ordinary skill in the art from this disclosure that the sub-layer 323 can be integral with the first portion 303 and the first face member 306, i.e. the sub-layer 323 can extend out of a large area of an undersurface of the first portion 303. The tongue 326 extends generally perpendicular from the flange 324 at an end of the flange 324 opposite the sub-layer 323. The tongue 326 is configured to contact the inside of the front or outermost part 143 of the gutter 144. Specifically, the tongue 326 is configured to be inserted into the pocket 141 of the gutter 144. The first face member 306 protects the gutter 144 and also provides a surface for the ladder 150 to rest thereon. Preferably, the flange 324 and tongue 326 hook into the outermost part 143 of the gutter 144 at the pocket 141.

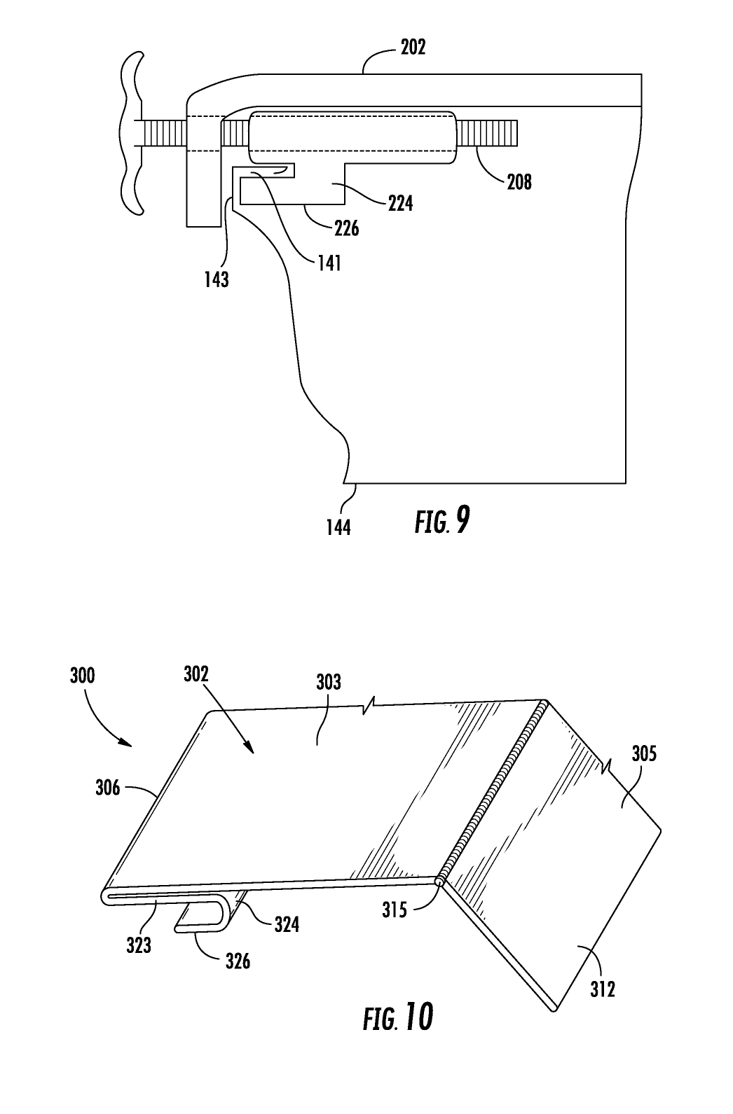

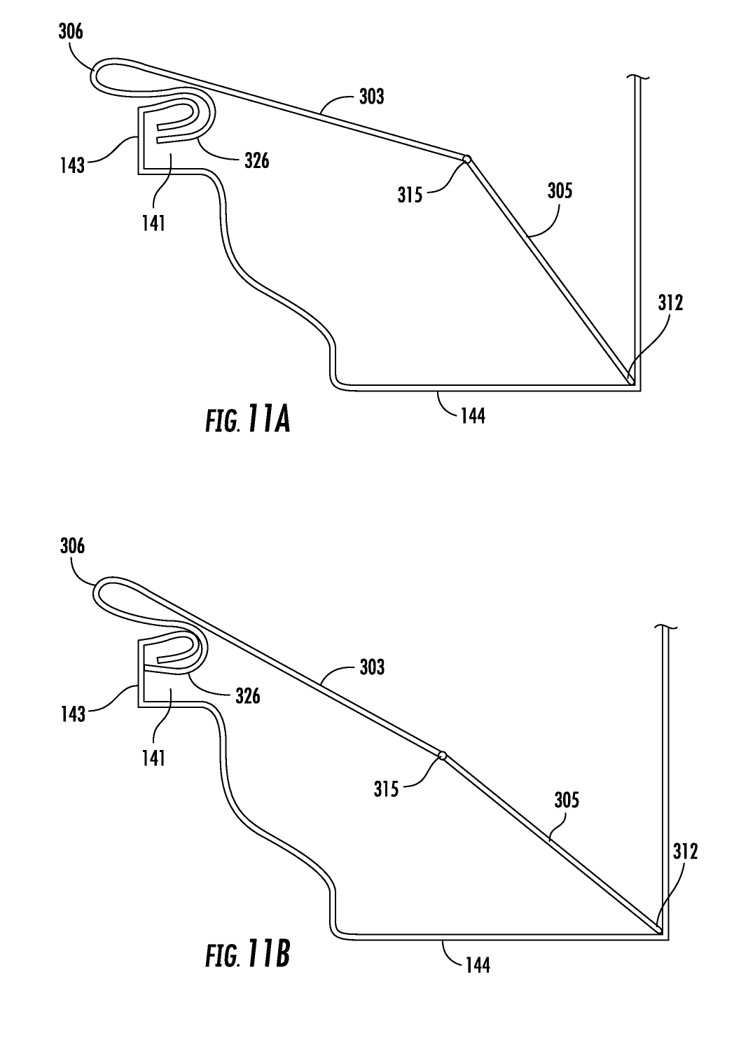

Referring to FIG. 11A, the tongue 326 is disposed in the pocket 141 and the hinge 315 is disposed such that the first portion 303 and the second portion 305 are at an obtuse angle from each other. Still referring to FIG. 11A, the second face member 312 is disposed in a lower corner of the gutter. Now referring to FIG. 11B, the first and second portions are approximately 180° from each other. In other words, the first and second portions 303, 305 are generally disposed in the same plane. Or alternatively, the first and second portions 303, 305 delineate generally parallel planes. Once the plate 302 is positioned as shown in FIG. 11B, the location of the hinge 315 underneath the plate 302 aids in keeping the first and second portions 303, 305 substantially in the same plane. The first face member 306 extends outwardly and above the outermost part 143 of the gutter 144. This position of the face member 306 provides a surface for the ladder 150 to rest thereon. The ladder 150 is secured to the first face member 306 by the means 120 for securing the ladder 150.

The ladder support apparatus 300 advantageously provides an apparatus with few parts that can be folded for compact storage. The ladder support apparatus 300 is also easily placed into the gutter 144, as seen in FIG. 11A and secured in the gutter 144 for supporting the ladder 150, as seen in FIG. 11B.

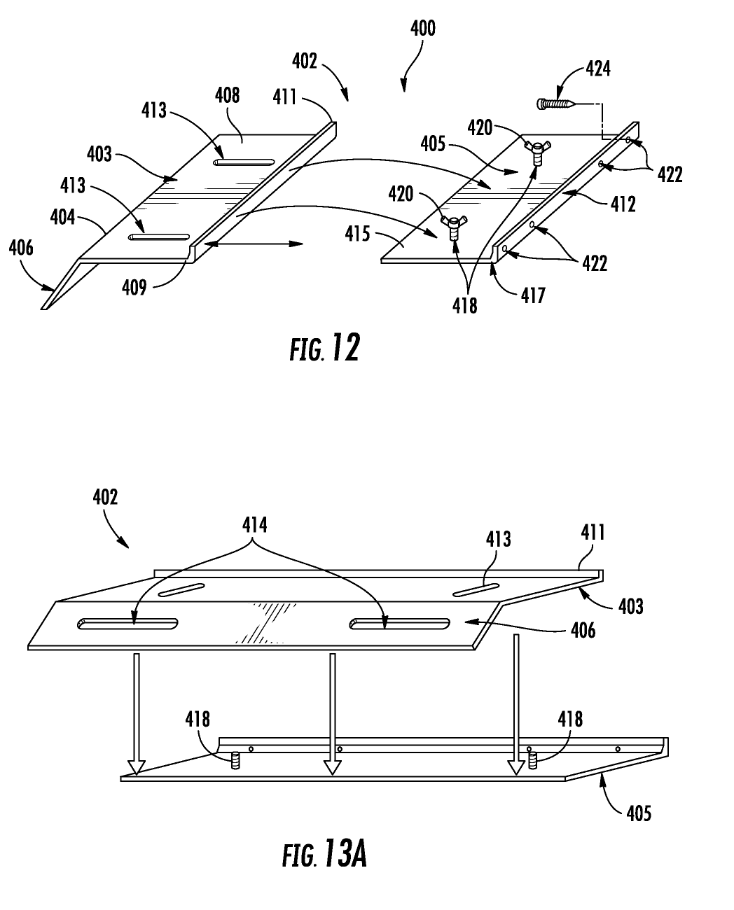

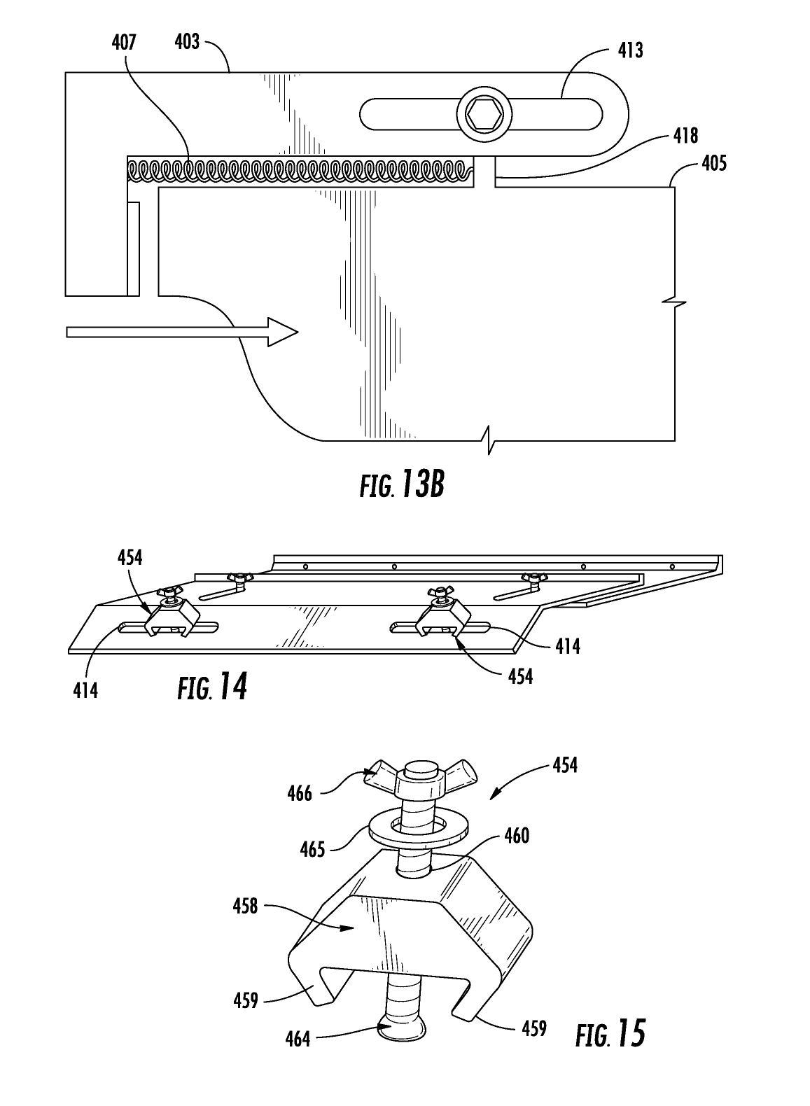

FIG. 12 illustrates a fourth embodiment of the ladder support apparatus 400 that attaches to the fascia board 142 and lies over the gutter 144. The ladder support apparatus 400 includes a plate 402 having a first face member 406, and a second face member 412. The plate 402 includes a first portion 403 and a second portion 405 that are made of metal, specifically heavy gauge extrusion. The plate 402 is about 28 to 30 inches wide, for example, to accommodate the ladder 150. The first portion 403 is bent along an edge or corner 404 to form the first face member 406 which is formed at an angle to a plate surface 408. A second bend along an edge or corner 409 forms an intermediate face member 411, which is generally perpendicular to the plate surface 408. The plate surface 408 includes a plurality of slots 413 that run laterally across the plate surface 408. Referring to FIG. 13A, the first face member 406 also includes a plurality of slots 414 that run longitudinally across the first face member 406.

The second portion 405 has a glide face 415 on which the first portion 403 glides forwards and backwards. The second portion 405 is bent along an edge or corner 417 to form a second face member 412. The corner 417 includes an angular reinforcement that helps keep the second face member 412 from bending. Specifically, the corner 417 has an increased width such that another face is disposed between the second face member 412 and the glide face 415. The second portion 405 includes bolts or a threaded rod 418 having mating wing nuts 420. Preferably, the wing nuts 420 are heavy gauge. The bolts 418 extend perpendicularly out of the glide face 415 and are configured to extend through the slots 413 in the plate surface 408. That is, the bolts 418 are spaced apart and have a diameter to allow entry into slots 413 from the underside of the plate surface 408. The bolts 418 can be welded or bolted with a nut to the plate surface 408. Once the bolts 418 are disposed in the slots 413, a corresponding one of the wing nuts 420 is threaded onto the bolt 418.

Thus, the ladder support apparatus 400 can be expanded by sliding the first portion 403 over the second portion 405. Specifically, the first portion 403 can be selectively positioned at a desired distance away from the fascia board 142 so as to achieve a most favorable position of the ladder 150. This allows the first and second portions 403 and 405 to expand or contract to accommodate different size gutters 144. The ladder 150 is secured to the first face member 406 by the means 120 for securing the ladder 150. Specifically, the means 120 is inserted through the slot 414 and secured to the ladder 150.

The second face member 412 is configured to attach to the fascia board 142. The second face member 412 has apertures 422 for screws 424 to extend therethrough. Preferably, the apertures 422 are downward sloping holes and are spaced so as to fit screws 424 in rafters at 16″ or 24″ on centers. Preferably, the screws 424 are self tapping metal/wood screws of #10 or #12 diameter that are at least 2.5 inches long, course thread that when installed properly will enter into rafters or the fascia board 142.

While not illustrated, it will be apparent to one of ordinary skill in the art that washers can be utilized in conjunction with the bolts 418 and wing nuts 420. Furthermore, nuts can be used in place of wing nuts 420.

FIG. 13B illustrates an alternative embodiment for connecting the first and second portions 403, 405 and for securing the ladder support apparatus 400 to the gutter 144. Specifically, the second portion 405 includes a pin 418 that extends perpendicular to the glide face 415 and is disposed in a slot 413 cut out of the first portion 403. A spring 407 is attached to the pin 418 at one end and attached to a backside of the first face member 406 at another end. The spring 407 exerts a force to pull the first face member 406 toward the pin 418. The first portion 403 slides along the slot 413 as a result of the spring force. In operation, the backside of the first face member 406 abuts against the outermost portion 143 of the gutter 144 as a result of the spring force.

Referring to FIGS. 14-17, a fourth embodiment of the means 120 for securing the ladder 150 includes a ladder mount apparatus 454. The ladder mount apparatus 454 includes a main block 458 that is made of heavy, extruded aluminum, alloy or steel. The main block 458 is shaped to lie on a rail 153 of the ladder 150 from either side of the ladder stile 151. The main block 458 has a hole 460 running therethrough that is configured to receive a carriage bolt 464. The carriage bolt 464 corresponds in size to the slots 414 so as to slide side to side in the slots 414. The bolt 464 is of an appropriate length to extend through the hole 460 and so as to accommodate up and down movement for placement of block 458 onto the rail or stile 151 of the ladder 150.

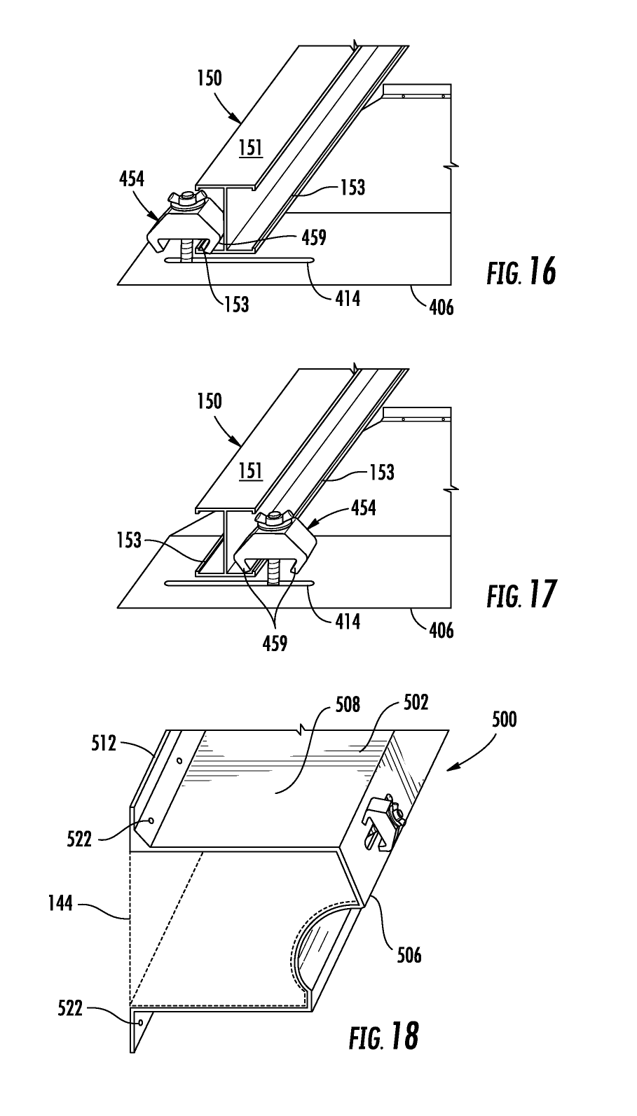

Referring to FIG. 14, the ladder mount apparatus 454 is disposed at the first face member 406 and has a washer 465 and wing nut 466 disposed on the bolt 464. The wing nut 466 is used to tighten the main block section down onto the ladder 150. Specifically, referring to FIGS. 16 and 17, the ladder mount apparatus 454, the slot 414 and the first face member 406 constitute a clamping mechanism for securing the ladder 150. Typically, ladder stiles 151, having rails 153, form either an “L” beam shape or an “I” beam shape. For either shape, the ladder mount apparatus 454 is able to fit over the inner or outer rail 153 to clamp the ladder 150 to the first face member 406. Specifically, the mount block 458 includes extensions 459 on either side for pinning the rail 153 of the ladder 150 between the first face member 406 and the main block 458. Thus, the ladder mount apparatus 454, when tightened properly, prevents slippage of the ladder 150.

FIG. 18 illustrates a fifth embodiment of the ladder support apparatus 500 that includes a plate 502 that encompasses the gutter 144. The plate 502 has a first face member 506 and a second face member 512. The first face member 506 wraps around the front of the gutter 144 and the underside of the gutter 144 following the shape of the gutter 144. The first face member 560 is configured to protect the gutter 144 and provides a surface for the ladder 150 to rest thereon. A plate surface 508 of the plate 502 covers the top of the gutter 144. A bend along an edge of the plate surface 508 forms the second face member 512. Specifically, the second face member 512 extends generally perpendicularly from the plate surface 508. The first and second face members 506 and 512 are attached to a wall and fascia board 142, respectively, by inserting screws (not shown) through apertures 522.

The ladder support apparatus 500 advantageously provides an apparatus with few parts that is easily set into place for use with the ladder 150. The plate 502 can be formed from metal, by way of example, a light gauge steel or aluminum; although, other materials may be used without departing from the scope of the present invention. Examples of other materials include alloys, such as steel, brass, bronze and duralumin, plastic, wood, high density polyethelene, PVC, polycarbonate, accrylonitrile butadiene styrene, or polycarbonate/accrylonitrile butadiene styrene.

FIGS. 19 & 20 illustrate a sixth embodiment of the ladder support apparatus 600 that includes a plate 602 having a portion inserted into the gutter 144. The plate 602 has a first face member 606 and a second face member 612. The first face member 606 is disposed in front of the gutter 144 and is configured to protect the gutter 144 as well as provide a surface for the ladder 150 to rest thereon. A plate surface 608 covers the top of the gutter 144 and a bend along an edge of the plate surface 608 forms the second face member 612. The second face member 612 generally extends perpendicularly from the plate surface 608 at a corner 617. The second face member 612 is attached to the fascia board 142 by inserting screws (not shown) through apertures 622.

The corner 617 includes an angular reinforcement that helps keep the second face member 612 from bending. Specifically, the corner 617 has an increased width such that another face is disposed between the second face member 612 and the plate surface 608. The apertures 622 run through the angular reinforcement of the corner 617. Thus, the angular reinforcement also provides a sturdy location for the ladder support apparatus 600 to be secured to the fascia board 142.

The ladder support apparatus 600 further includes first and second support members 624, 626 that are disposed on an underside of the plate surface 608. The first and second support member 624, 626 are generally disposed in the gutter 144 and provide support as well as leverage for the ladder support apparatus 600. The first support member 624 is generally parallel to the second face member 612 and perpendicular to the plate surface 608. The second support member 626 extends from the plate surface 608 to a edge of the first support member 624 at about a 45 degree angle. Thus, the plate surface 608, the first support member 624, and the second support member 626 form a triangular shape underneath the plate surface 608. The corner formed by the first support member 624 and the second support member 626 is disposed in a lower back corner of the gutter 144.

The ladder support apparatus 600 can be formed from metal, for example, a light gage steel or aluminum. Preferably, the ladder apparatus 600 is extruded aluminum.

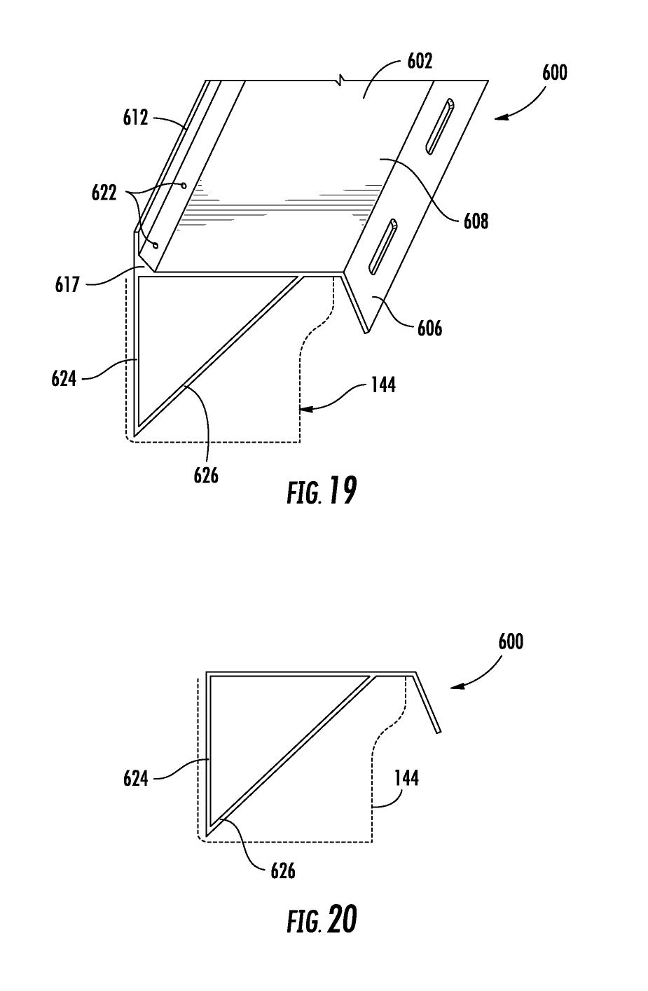

FIGS. 21 & 22 illustrate a pivot piece for use in connection with the ladder support apparatus. The pivot piece 650 is configured to be disposed between the ladder support apparatus 100 and the fascia board 142. Specifically, the pivot piece 650 is configured to compensate for an angled fascia board 142 which would otherwise cause the ladder stiles 151 to rest awkwardly on the fascia board 142. The pivot piece 650 has a plurality of apertures on the ends to receive pins and/or screws. Accordingly, the ladder support apparatus 100 is attached to the apertures on one side of the pivot piece 650 and the pivot piece 650 is attached to the fascia board 142 on the other side. The pivot piece 650 can be made of various materials that are strong enough to retain their general shape when weight is applied but flexible enough to absorb minor vibrations or shock.

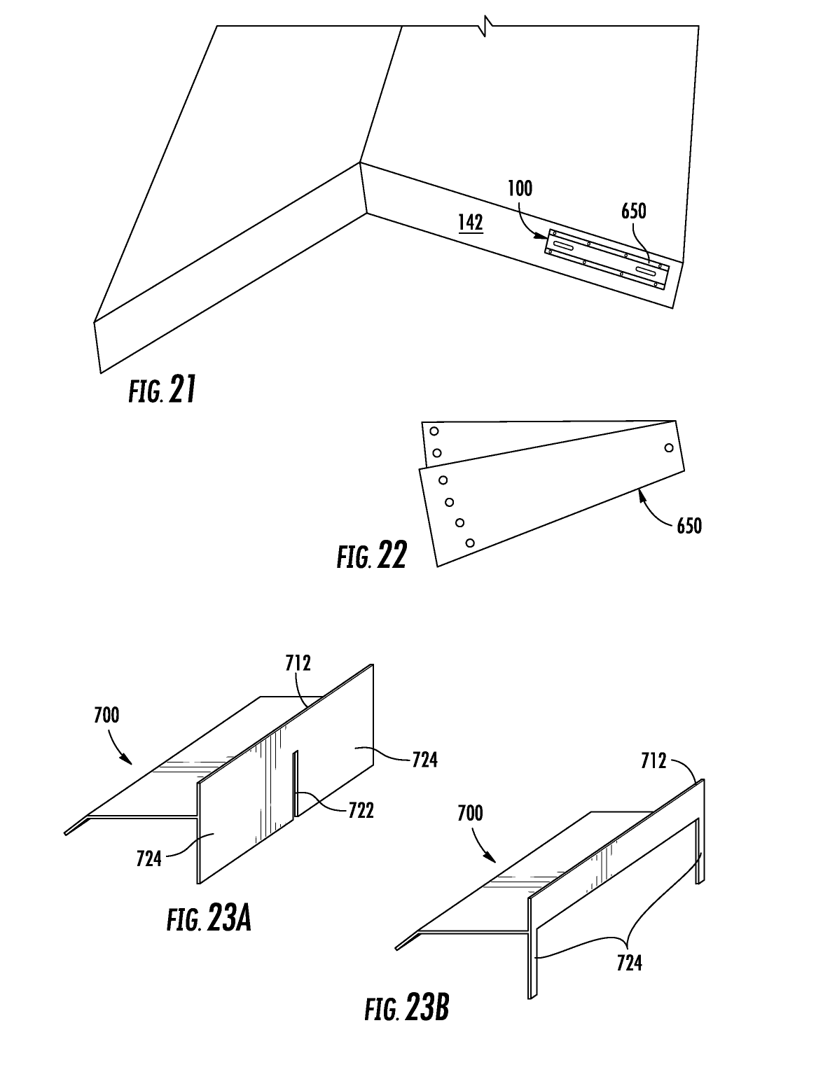

Referring to FIG. 3, a typical gutter 144 having a band 145 crossing the gutter 144 is shown. In order to provide a ladder mount and ladder support apparatus that can accommodate the band 145, an aperture 723 is provided to accommodate the band 145. Thus, the apparatus can be advantageously placed in the gutter without regard to avoiding the bands 145. FIGS. 23A and 23B illustrate embodiments wherein support members 724 are disposed underneath the second face member 712. The support members 724 have various widths to provide a wide or narrow aperture 723.

Changes may be made to the foregoing apparatus, devices and systems without departing from the scope of the present invention. It should be noted that the matter contained in the above description and/or shown in the accompanying figures should be interpreted as illustrative and not in a limiting sense. The following claim(s) are intended to cover all generic and specific features described herein as well as statements of the scope of the present invention, which, as a matter of language, might be said to fall there between.

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, and/or steps. The foregoing also applies to words having similar meanings such as the terms, “including”, “having” and their derivatives. The terms of degree such as “substantially”, “about” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Thus, the foregoing descriptions of the embodiments according to the present invention are provided for illustration only, and not for the purpose of limiting the invention as defined by the appended claims and their equivalents.

What is claimed is:

1. A gutter protection and ladder support apparatus comprising:
a plate section having a plate surface and bent to form a first face member and a second face member, the first face member being formed at an angle from the plate surface; and
a ladder securing apparatus connected to the plate section and configured to secure a ladder against the plate section, the ladder securing apparatus being adjustable for selective fastening of the ladder to the plate section.

2. The gutter protection and ladder support apparatus of claim 1, wherein
the second face member is substantially perpendicular to the plate surface and configured to abut a fascia board.

3. The gutter protection and ladder support apparatus of claim 1, wherein
the ladder securing apparatus is adjustable and includes a chain for the selective fastening of the ladder to the plate section.

4. The gutter protection and ladder support apparatus of claim 1, wherein
the ladder securing apparatus is adjustable and includes a ladder mount apparatus slidably moveable in a longitudinal direction of the first face member.

5. The gutter protection and ladder support apparatus of claim 4, wherein
the ladder mount apparatus includes a block with at least one extension for pinning a ladder to the first face member.

6. The gutter protection and ladder support apparatus of claim 1, wherein
the ladder securing apparatus is adjustable and includes a ladder mount apparatus moveable in a transverse direction of the plate section.

7. The gutter protection and ladder support apparatus of claim 1, wherein
the plate surface has a hinge located between the first and second face members.

8. The gutter protection and ladder support apparatus of claim 1, wherein
the first face member is configured to move away from the second face member.

9. The gutter protection and ladder support apparatus of claim 1, wherein
the plate section includes a first portion and a second portion, and the first face member is located at the first portion and the second face member is located at the second portion.

10. The gutter protection and ladder support apparatus of claim 9, wherein
the first portion is slidably disposed over the second portion.

11. The gutter protection and ladder support apparatus of claim 1, wherein
the first face member is shaped to wrap around a gutter following the shape of the gutter.

12. The gutter protection and ladder support apparatus of claim 1, further comprising
a support member disposed on an under side of the plate section and configured to extend into a gutter.

13. The gutter protection and ladder support apparatus of claim 13, wherein
an aperture is formed between two support members.

14. The gutter protection and ladder support apparatus of claim 1, further comprising
a pivot piece disposed between the second face member and an angled fascia board, the pivot piece being configured to compensate for the angled fascia board.
